(19) United States
(12) Patent Application Publication
(10) Pub. No.: US 2006/0024561 A1
(43) Pub. Date: Feb. 2, 2006

(54) Fuel cell stack

(76) Inventors: Masahiko Sato, Utsunomiya-shi (JP); Shuhei Goto, Utsunomiya-shi (JP); Tadashi Nishiyama, Sakura-shi (JP)

Correspondence Address: FISH & RICHARDSON P.C., P.O. BOX 1022, MINNEAPOLIS, MN, 55440-1022, US

(21) Appl. No.: 11/191,211

(22) Filed: Jul. 26, 2005

(30) Foreign Application Priority Data
Aug. 2, 2004 (JP) 2004-225229

(51) Int. Cl. H01M 8/24; H01M 8/02; H01M 8/04

(52) U.S. Cl. 429/38; 429/34; 429/26

(57) ABSTRACT

A terminal plate, an insulating plate, and an end plate are stacked together. A rectangular recess is formed at the center of the insulating plate. The terminal plate is placed in the recess. An oxygen-containing gas supply passage, a coolant supply passage, a fuel gas discharge passage, a fuel gas supply passage, a coolant discharge passage, and an oxygen-containing gas discharge passage as fluid passages extend through the insulating plate. These fluid passages do not extend through the terminal plate.

### BACKGROUND OF THE INVENTION

1. Field of the Invention

The present invention relates to a fuel cell stack comprising a plurality of unit cells stacked together in a stacking direction, and terminal plates, insulating members, and end plates provided at opposite ends of the unit cells in the stacking direction. Each of the unit cells includes an electrolyte electrode assembly and a pair of separators sandwiching the electrolyte electrode assembly. The electrolyte electrode assembly includes a pair of electrodes, and an electrolyte interposed between the electrodes.

2. Description of the Related Art

For example, a solid polymer fuel cell employs a membrane electrode assembly which includes an anode and a cathode each having a catalyst and porous carbon particles, and an electrolyte membrane (electrolyte) interposed between the anode and the cathode. The electrolyte membrane is a polymer ion exchange membrane. The membrane electrode assembly and separators (bipolar plates) sandwiching the membrane electrode assembly make up a unit of a fuel cell (unit cell) for generating electricity.

In the fuel cell, a fuel gas such as a gas chiefly containing hydrogen (hereinafter also referred to as the “hydrogen-containing gas”) is supplied to the anode. A gas chiefly containing oxygen or the air (hereinafter also referred to as the “oxygen-containing gas”) is supplied to the cathode. The catalyst of the anode induces a chemical reaction of the fuel gas to split the hydrogen molecule into hydrogen ions and electrons. The hydrogen ions move toward the cathode through the electrolyte membrane, and the electrons flow through an external circuit to the cathode, creating a DC electrical energy.

In general, in the so-called internal manifold type fuel cell, fluid supply passages and fluid discharge passages extend through the separators in the stacking direction. The fluids, i.e., the fuel gas, the oxygen-containing gas, and the coolant are supplied to the fuel gas flow field, the oxygen-containing gas flow field, and the coolant flow field through the respective fluid supply passages, and discharged from the fuel gas flow field, the oxygen-containing gas flow field, and the coolant flow field through the respective fluid discharge passages.

In the internal manifold type fuel cell, the fluid supply passages and the fluid discharge passages also extend through the terminal plates or the end plates as necessary. In this case, metal plates such as the terminal plates contact the water produced in the reaction or the coolant water. Therefore, corrosion current flows through the metal plates easily, and electrical corrosion may occur in the metal plates undesirably.

In this regard, for example, a fuel cell stack disclosed in Japanese Laid-Open Patent Publication No. 8-130028 is known. In the conventional technique, as shown in FIG. 7, a current collecting plate 2 is provided on the side surface of a separator 1 of a unit cell. An electrical insulating plate 3 is provided on the side surface of the current collecting plate 2. A through hole 4 extends through the separator 1, the current collecting plate 2, and the electrically insulating plate 3 in a stacking direction. A pipe connector 5 is attached to the electrically insulating plate 3. A cooling fluid is supplied from the pipe connector 5 into the through hole 4. An insulating bushing 6 is attached to the current collecting plates 3 around the through hole 4.

In general, six through holes 4 are provided for the fuel gas, the oxygen-containing gas, and the coolant. In the conventional technique described above, insulating bushings 6 are attached to the current collecting plate 3 around the through holes 4. At least six insulating bushings 6 are required for each of the current collecting plates 2. Therefore, the number of components of the unit cell is large, and the unit cell cannot be produced economically.

### SUMMARY OF THE INVENTION

A main object of the present invention is to provide a fuel cell stack having a simple and economical structure in which terminal plates are insulated suitably.

The present invention relates to a fuel cell stack comprising a plurality of unit cells stacked together in a stacking direction, and terminal plates, insulating members, and end plates provided at opposite ends of the unit cells in the stacking direction. Each of the unit cells includes an electrolyte electrode assembly and a pair of separators sandwiching the electrolyte electrode assembly. The electrolyte electrode assembly includes a pair of electrodes, and an electrolyte interposed between the electrodes.

A recess is formed at the center of at least one of the insulating members, and the terminal plate is placed in the recess. A fluid passage extends through the insulating member outside the recess for allowing at least a reactant gas or a coolant to flow through the fluid passage.

Preferably, the reactant gas comprises a fuel gas and an oxygen-containing gas, and the fluid passage comprises a fuel gas supply passage, a fuel gas discharge passage, an oxygen-containing gas supply passage, an oxygen-containing gas discharge passage, a coolant supply passage, and a coolant discharge passage.

In the present invention, the terminal plate is placed in the recess of the insulating plate. The fluid passage extends through the insulating plate, and does not extend through the terminal plate. Therefore, insulating members such as insulating bushings which are attached to the terminal plate in the conventional structure are not required. Thus, with the simple and economical structure, the terminal plate is insulated suitably.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a partial exploded perspective view schematically showing a fuel cell stack according to an embodiment of the present invention;

FIG. 2 is a perspective view schematically showing the fuel cell stack;

FIG. 3 is a partial cross sectional side view showing the fuel cell stack;

FIG. 4 is an exploded perspective view showing main components of a unit cell of the fuel cell stack;

FIG. 5 is a cross sectional view showing main components of the fuel cell stack;

FIG. 6 is an exploded perspective view showing an end plate, an insulating plate, and a terminal plate provided at one end of the fuel cell stack; and

FIG. 7 is a cross sectional view showing part of a conventional fuel cell.

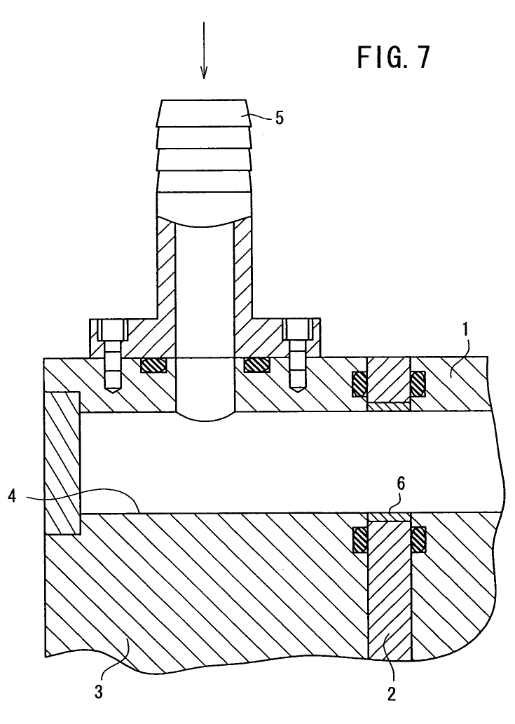

### DESCRIPTION OF THE PREFERRED EMBODIMENTS

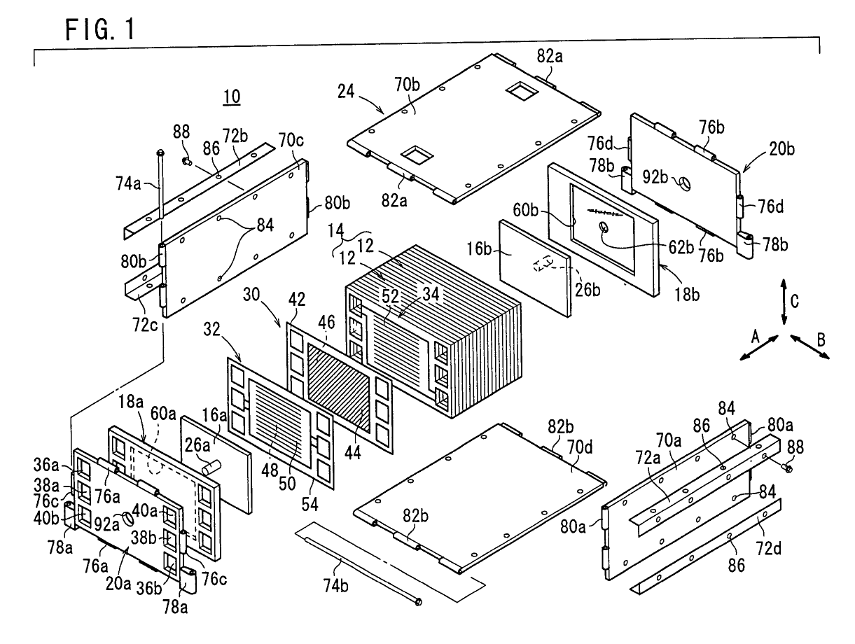

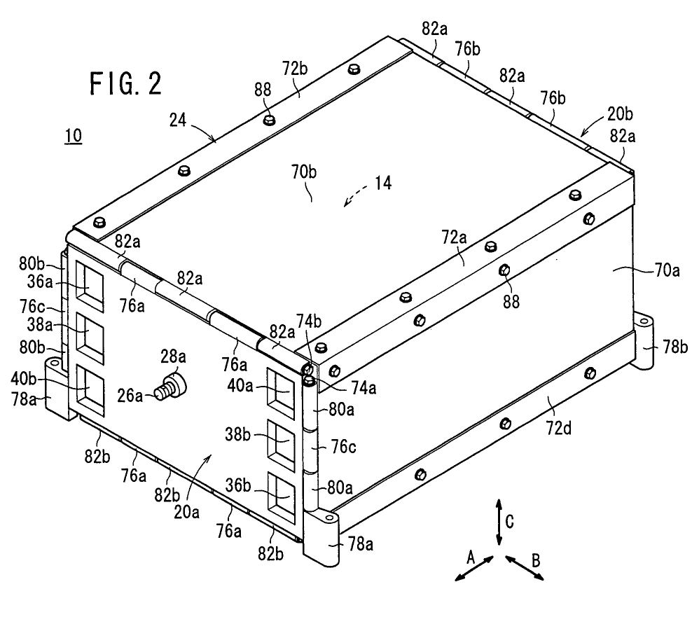

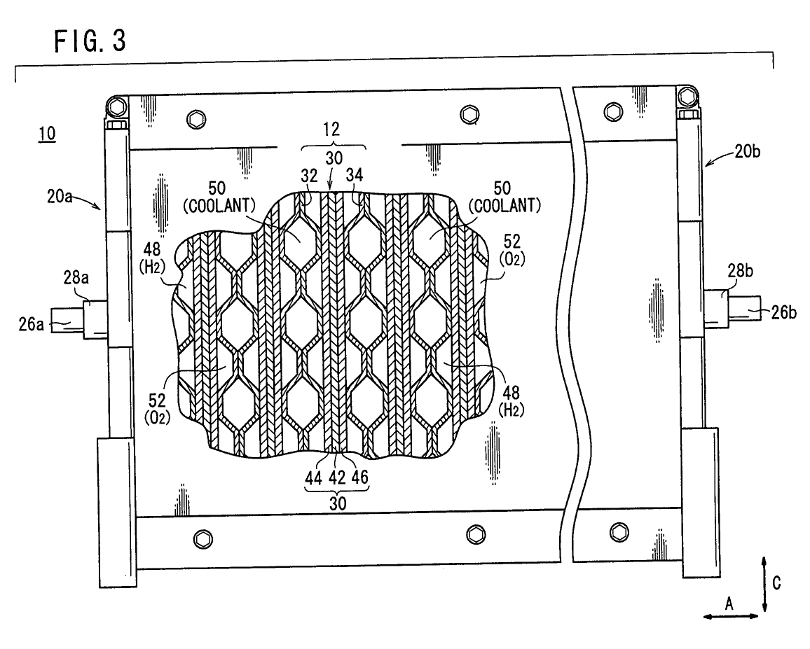

FIG. 1 is a partial exploded perspective view schematically showing a fuel cell stack 10 according to an embodiment of the present invention. FIG. 2 is a perspective view schematically showing the fuel cell stack 10. FIG. 3 is a partial cross sectional side view showing the fuel cell stack 10.

As shown in FIG. 1, the fuel cell stack 10 includes a stack body 14 formed by stacking a plurality of unit cells 12 horizontally in a stacking direction indicated by an arrow A. At one end of the stack body 14 in the stacking direction indicated by the arrow A, a terminal plates 16a is provided. An insulating plate (insulating member) 18a is provided outside the terminal plate 16a. Further, an end plate 20a is provided outside the insulating plate 18a.

At the other end of the stack body 14 in the stacking direction, a terminal plate 16b is provided. An insulating plate (insulating member) 18b is provided outside the terminal plate 16b. Further, an end plate 20b is provided outside the insulating plate 18b. Each of the end plates 20a, 20b has a rectangular shape. The fuel cell stack 10 is assembled together such that the stack body 14 formed by stacking the unit cells 12 is housed in a casing 24 including the end plates 20a, 20b.

As shown in FIG. 1, a terminal 26a is provided at substantially the center of the terminal plate 16a, and a terminal 26b is provided at substantially the center of the terminal plate 16b. The terminals 26a, 26b are inserted into insulating cylinders 28a, 28b, and extend outwardly from the end plates 20a, 20b, respectively (see FIG. 3).

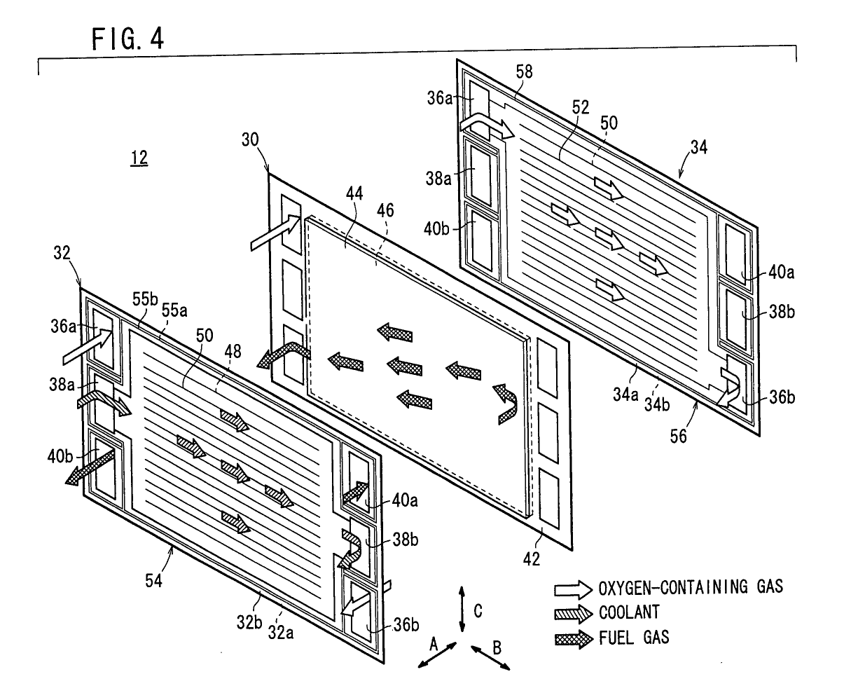

As shown in FIGS. 3 and 4, each of the unit cells 12 includes a membrane electrode assembly (electrolyte electrode assembly) 30 and first and second metal separators 32, 34 sandwiching the membrane electrode assembly 30. The first and second metal separators 32, 34 are thin metal plates fabricated to have corrugated surfaces, or dimples by press forming. Therefore, the first and second metal separators 32, 34 have protrusions and grooves in cross section. Instead of using the first and second metal separators 32, 34, for example, carbon separators may be used.

At one end of the unit cell 12 in a longitudinal direction indicated by an arrow B in FIG. 4, an oxygen-containing gas supply passage (fluid passage) 36a for supplying an oxygen-containing gas, a coolant supply passage (fluid passage) 38a for supplying a coolant, and a fuel gas discharge passage (fluid passage) 40b for discharging a fuel gas such as a hydrogen-containing gas are provided. The oxygen-containing gas supply passage 36a, the coolant supply passage 38a, and the fuel gas discharge passage 40b extend through the unit cell 12 in the direction indicated by the arrow A.

At the other end of the unit cell 12 in the longitudinal direction, a fuel gas supply passage (fluid passage) 40a for supplying the fuel gas, a coolant discharge passage (fluid passage) 38b for discharging the coolant, and an oxygen-containing gas discharge passage (fluid passage) 36b for discharging the oxygen-containing gas are provided. The fuel gas supply passage 40a, the coolant discharge passage 38b, and the oxygen-containing gas discharge passage 36b extend through the unit cell 12 in the direction indicated by the arrow A.

The membrane electrode assembly 30 includes an anode 44, a cathode 46, and a solid polymer electrolyte membrane 42 interposed between the anode 44 and the cathode 46. The solid polymer electrolyte membrane 42 is formed by impregnating a thin membrane of perfluorosulfonic acid with water, for example.

Each of the anode 44 and the cathode 46 has a gas diffusion layer (not shown) such as a carbon paper, and an electrode catalyst layer (not shown) of platinum alloy supported on porous carbon particles. The carbon particles are deposited uniformly on the surface of the gas diffusion layer. The electrode catalyst layer of the anode 44 and the electrode catalyst layer of the cathode 46 are fixed to both surfaces of the solid polymer electrolyte membrane 42, respectively.

The first metal separator 32 has a fuel gas flow field 48 on its surface 32a facing the membrane electrode assembly 30. The fuel gas flow field 48 is connected to the fuel gas supply passage 40a at one end, and connected to the fuel gas discharge passage 40b at the other end. The fuel gas flow field 48 includes a plurality of grooves extending in the direction indicated by the arrow B, for example. Further, the first metal separator 32 has a coolant flow field 50 on the other surface 32b. The coolant flow field 50 is connected to the coolant supply passage 38a at one end, and connected to the coolant discharge passage 38b at the other end. The coolant flow field 50 includes a plurality of grooves extending in the direction indicated by the arrow B.

The second metal separator 34 has an oxygen-containing gas flow field 52 on its surface 34a facing the membrane electrode assembly 30. The oxygen-containing gas flow field 52 is connected to the oxygen-containing gas supply passage 36a at one end, and connected to the oxygen-containing gas discharge passage 36b at the other end. The oxygen-containing gas flow field 52 includes a plurality of grooves extending in the direction indicated by the arrow B. The other surface 34b of the second metal separator 34 is stacked on the surface 32b of the adjacent first metal separator 32. When the first metal separator 32 and the second metal separator 34 are stacked together, the coolant flow field 50 is formed between the surface 32b of the first metal separator 32 and the surface 34b of the second metal separator 34.

A first seal member 54 is formed integrally on the surfaces 32a, 32b of the first metal separator 32 around the outer end of the first metal separator 32. On the surface 32a, the first seal member 54 is formed around the fuel gas supply passage 40a, the fuel gas discharge passage 40b, and the fuel gas flow field 48 for preventing leakage of the fuel gas, while allowing the fuel gas to flow between the fuel gas supply passage 40a and the fuel gas flow field 48, and between the fuel gas flow field 48 and the fuel gas discharge passage 40b. Further, on the surface 32b, the first seal member 54 is formed around the coolant supply passage 38a, the coolant discharge passage 38b, and the coolant flow field 50 for preventing leakage of the coolant, while allowing the coolant to flow between the coolant supply passage 38a and the coolant flow field 50, and between the coolant flow field 50 and the coolant discharge passage 38b. The first seal member 54 includes a ridge seal 55a on the surface 32a, and a ridge seal 55b on the surface 32b.

A second seal member 56 is formed integrally on the surfaces 34a, 34b of the second metal separator 34 around the outer end of the second metal separator 34. On the surface 34a, the second seal member 56 is formed around the oxygen-containing gas supply passage 36a, the oxygen-containing gas discharge passage 36b, and the oxygen-containing gas flow field 52, and prevents leakage of the oxygen-containing gas, while allowing the oxygen-containing gas to flow between the oxygen-containing gas supply passage 36a and the oxygen-containing gas flow field 52, and between the oxygen-containing gas flow field 52 and the oxygen-containing gas discharge passage 36b. Further, on the surface 34b, the second seal member 56 is formed around the coolant supply passage 38a, the coolant discharge passage 38b, and the coolant flow field 50, and prevents leakage of the coolant while allowing the coolant to flow between the coolant supply passage 38a and the coolant flow field 50, and between the coolant flow field 50 and the coolant discharge passage 38b. The second seal member 56 includes a ridge seal 58 on the surface 34a.

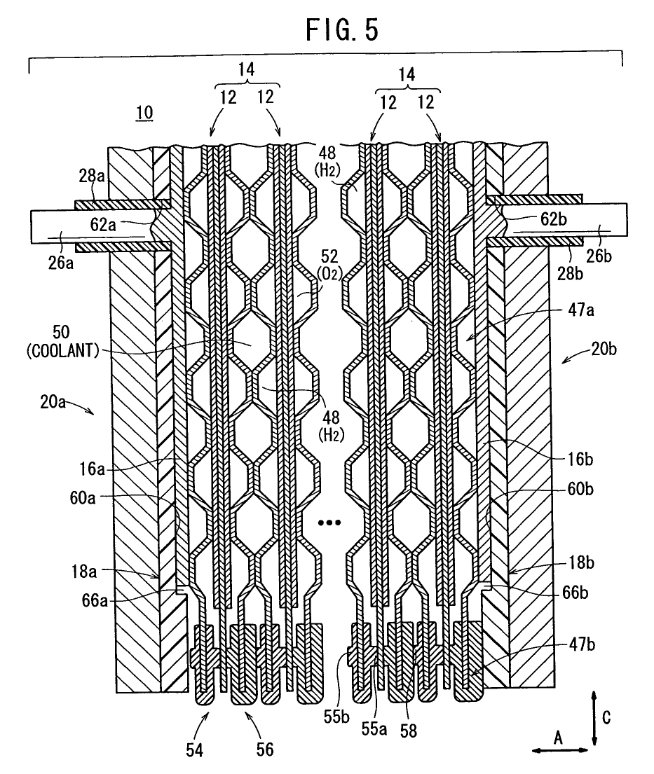

In FIGS. 1 and 5, the insulating plates 18a, 18b are made of insulating material such as polycarbonate (PC) or phenol resin. A rectangular recess 60a is formed at the center of the insulating plate 18a, and a rectangular recess 60b is formed at the center of the insulating plate 18b. A hole 62a is formed at substantially the center of the recess 60a, and a hole 62b is formed at substantially the center of the recess 60b. The terminal plates 16a, 16b are placed in the recesses 60a, 60b, respectively. The terminals 26a, 26b of the terminal plates 16a, 16b are inserted into the holes 62a, 62b through the insulating cylinders 28a, 28b, respectively.

As shown in FIG. 1, the casing 24 includes the end plates 20a, 20b, a plurality of side plates 70a to 70d, angle members (e.g., L angles) 72a to 72d, and coupling pins 74a, 74b. The side plates 70a to 70d are provided on sides of the stack body 14. The angle members 72a to 72d are used for coupling adjacent ends of the side plates 70a to 70d. The coupling pins 74a, 74b are used for coupling the end plates 20a, 20b and the side plates 70a to 70d. The coupling pins 74b are longer than the coupling pins 74a.

Each of upper and lower ends of the end plate 20a has two first coupling portions 76a. Each of upper and lower ends of the end plate 20b has two first coupling portions 76b. Each of left and right ends of the end plate 20a has one first coupling portion 76c. Each of left and right ends of the end plate 20b has one first coupling portion 76d. The end plate 20a has mounting bosses 78a on its left and right ends at lower positions. The end plate 20b has mounting bosses 78b on its left and right ends at lower positions. The bosses 78a, 78b are fixed to mounting positions (not shown) using bolts or the like for installing the fuel cell stack 10 in a vehicle, for example.

The side plates 70a, 70c are provided on opposite sides of the stack body 14 in the lateral direction indicated by the arrow B. Each longitudinal end of the side plate 70a has two second coupling portions 80a. Each longitudinal end of the side plate 70c has two second coupling portions 80b. The side plate 70b is provided on the upper side of the stack body 14, and the side plate 70d is provided on the lower side of the stack body 14. Each longitudinal end of the side plate 70b has three second coupling portions 82a. Each longitudinal end of the side plate 70d has three second coupling portions 82b.

The first coupling portions 76c of the end plate 20a, and the first coupling portions 76d of the end plate 20b are positioned between the second coupling portions 80a of the side plate 70a, and between the second coupling portions 80b of the side plate 70c. The short coupling pins 74a are inserted into these coupling portions 76c, 76d, 80a, 80b for coupling the side plates 70a, 70c, and the end plates 20a, 20b.

Likewise, the second coupling portions 82a of the side plate 70b and the first coupling portions 76a, 76b of the upper end of the end plates 20a, 20b are positioned alternately, and the second coupling portions 82b of the side plate 70d and the first coupling portions 76a, 76b of the lower end of the end plates 20a, 20b are positioned alternately. The long coupling pins 74b are inserted into these coupling portions 76a, 76b, 82a, 82b for coupling the side plates 70b, 70d and the end plates 20a, 20b.

A plurality of screw holes 84 are formed along opposite edges of the side plates 70a to 70d in the lateral direction. The screw holes 84 are arranged in the direction indicated by the arrow A. Further, holes 86 are provided along the lengths of the angle members 72a to 72d at positions corresponding to the screw holes 84. Screws 88 are inserted into the holes 86 and the screw holes 84. Thus, the side plates 70a to 70d are fixed together using the angle members 72a to 72d. In this manner, the side plates 70a to 70d, and the end plates 20a, 20b are assembled into the casing 24 (see FIG. 2).

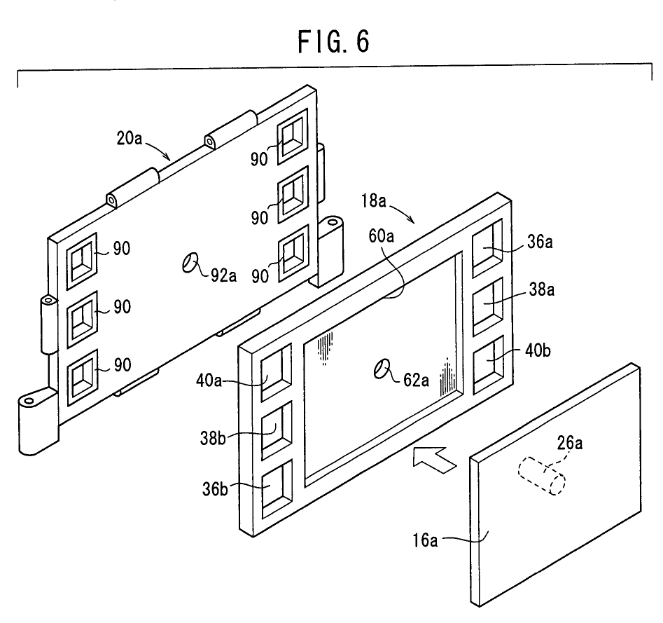

As shown in FIG. 6, insulating grommets 90 are attached to the end plate 20a, at the oxygen-containing gas supply passage 36a, the coolant supply passage 38a, the fuel gas discharge passage 40b, the fuel gas supply passage 40a, the coolant discharge passage 38b, and the oxygen-containing gas discharge passage 36b. In the drawings other than FIG. 6, the insulating grommets 90 are not shown. A hole 92a is formed at substantially the center of the end plate 20a, and a hole 92b is formed at substantially the center of the end plate 20b (see FIG. 1).

The angle members 72a to 72d may have screw holes, and the side plates 70a to 70d may have holes. In this case, the angle members 72a to 72d are placed inside the side plates 70a to 70d for fixing the angle members 72a to 72d and the side plates 70a to 70d together. Further, the angle members 72a to 72d may be formed integrally with any of the side plates 70a to 70d.

Next, operation of the fuel cell stack 10 will be described.

In the fuel cell stack 10, as shown in FIG. 2, an oxygen-containing gas is supplied to the oxygen-containing gas supply passage 36a from the end plate 20a of the fuel cell stack 10. A fuel gas such as a hydrogen-containing gas is supplied to the fuel gas supply passage 40a. Further, a coolant such as pure water, an ethylene glycol is supplied to the coolant supply passage 38a. Thus, the oxygen-containing gas, the fuel gas, and the coolant are supplied to each of the unit cells 12 stacked together in the direction indicated by the arrow A to form the stack body 14. The oxygen-containing gas, the fuel gas, and the coolant flow in the direction indicated by the arrow A.

As shown in FIG. 4, the oxygen-containing gas flows from the oxygen-containing gas supply passage 36a into the oxygen-containing gas flow field 52 of the second metal separator 34. The oxygen-containing gas flows along the cathode 46 of the membrane electrode assembly 30 for inducing an electrochemical reaction at the cathode 46. The fuel gas flows from the fuel gas supply passage 40a into the fuel gas flow field 48 of the first metal separator 32. The fuel gas flows along the anode 44 of the membrane electrode assembly 30 for inducing an electrochemical reaction at the anode 44.

Thus, in each of the membrane electrode assemblies 30, the oxygen-containing gas supplied to the cathode 46, and the fuel gas supplied to the anode 44 are consumed in the electrochemical reactions at catalyst layers of the cathode 46 and the anode 44 for generating electricity (see FIG. 3).

After the oxygen in the oxygen-containing gas is consumed at the cathode 46, the oxygen-containing gas flows into the oxygen-containing gas discharge passage 36b, and is discharged to the outside from the end plate 20a. Likewise, after the fuel gas is consumed at the anode 44, the fuel gas flows into the fuel gas discharge passage 40b, and is discharged to the outside from the end plate 20a.

The coolant flows from the coolant supply passage 38a into the coolant flow field 50 between the first and second metal separators 32, 34, and flows in the direction indicated by the arrow B. After the coolant is used for cooling the membrane electrode assembly 30, the coolant flows into the coolant discharge passage 38b, and is discharged to the outside from the end plate 20a.

In the embodiment, as shown in FIG. 6, the rectangular recess 60a is formed at the center of the insulating plate 18a, and the terminal plate 16a is placed in the recess 60a. Fluid passages including the oxygen-containing gas supply passage 36a, the coolant supply passage 38a, the fuel gas discharge passage 40b, the fuel gas supply passage 40a, the coolant discharge passage 38b, and the oxygen-containing gas discharge passage 36b extend through the insulating plate 18a outside the recess 60a.

Therefore, the fluid passages do not extend through the terminal plate 16a. It is not necessary to attach any insulating members such as the insulating bushings to the terminal plate 16a at the fluid passages. Thus, the insulating grommets 90 are only used for the end plate 20a. With the simple and economical structure, the terminal plate 16a is insulated suitably.

In the embodiment, the fluid passages do not extend through the insulating plate 18b. As necessary, the structure of the insulating plate 18b may be the same as the structure of the insulating plate 18a. The fluid passage may also extend through the insulating plate 18b.

In the fuel cell stack 10, the stack body 14 is placed in the box-shaped casing 24. In an alternative structure, for example, components between the end plates 20a, 20b may be tightened together by unillustrated tie rods.

While the invention has been particularly shown and described with reference to a preferred embodiment, it will be understood that variations and modifications can be effected thereto by those skilled in the art without departing from the spirit and scope of the invention as defined by the appended claims.

What is claimed is:

1. A fuel cell stack comprising a plurality of unit cells stacked together in a stacking direction, and terminal plates, insulating members, and end plates provided at opposite ends of said unit cells in the stacking direction, said unit cells each including an electrolyte electrode assembly and separators sandwiching said electrolyte electrode assembly, said electrolyte electrode assembly including a pair of electrodes, and an electrolyte interposed between said electrodes, wherein
a recess is formed at the center of at least one of said insulating members, and said terminal plate is placed in said recess; and
a fluid passage extends through said insulating member outside said recess for allowing at least a reactant gas or a coolant to flow through said fluid passage.

2. A fuel cell stack according to claim 1, wherein said terminal plate has a terminal extending in the stacking direction, and said terminal is inserted into holes formed in said insulating member and said end plate.

3. A fuel cell stack according to claim 2, wherein an insulating cylinder is fitted to the outside of said terminal.

4. A fuel cell stack according to claim 1, further comprising a casing for accommodating said unit cells, wherein said casing comprises:
said end plates; and
a plurality of side plates provided on sides of said unit cells, and connected to said end plates.

5. A fuel cell stack according to claim 1, wherein said reactant gas comprises a fuel gas and an oxygen-containing gas; and
said fluid passage comprises a fuel gas supply passage, a fuel gas discharge passage, an oxygen-containing gas supply passage, an oxygen-containing gas discharge passage, a coolant supply passage, and a coolant discharge passage.

6. A fuel cell stack according to claim 5, wherein said unit cells have a rectangular shape; and
among the six fluid passages comprising said fuel gas supply passage, said fuel gas discharge passage, said oxygen-containing gas supply passage, said oxygen-containing gas discharge passage, said coolant supply passage, and said coolant discharge passage, three fluid passages extend through one longitudinal end of said unit cells, and the other three fluid passages extend through the other longitudinal end of said unit cells.

7. A fuel cell stack comprising a plurality of unit cells stacked together in a stacking direction, and terminal plates, insulating members, and end plates provided at opposite ends of said unit cells in the stacking direction, said unit cells each including an electrolyte electrode assembly and separators sandwiching said electrolyte electrode assembly, said electrolyte electrode assembly including a pair of electrodes, and an electrolyte interposed between said electrodes, wherein
a fluid passage extends through at least one of said insulating members for allowing at least a reactant gas or a coolant to flow through said fluid passage.
